(19) United States
(12) Patent Application Publication
(10) Pub. No.: US 2013/0098473 A1
(43) Pub. Date: Apr. 25, 2013

(54) Tool for Removing and Installing Plugs and Method of Operation

(71) Applicant: Frank G. Wassil, JR., Verplanck, NY (US)

(72) Inventor: Frank G. Wassil, JR., Verplanck, NY (US)

(73) Assignee: CONSOLIDATED EDISON COMPANY OF NEW YORK, INC., New York, NY (US)

(21) Appl. No.: 13/277,697

(22) Filed: Oct. 20, 2011

(51) Int. Cl. F16K 43/00; F16L 55/00

(52) U.S. Cl. 137/15.12; 137/315.42

(57) ABSTRACT

A tool for extracting a plug from a pipe containing a pressurized gas is provided. The tool includes a chamber member having an open end and a closed end, the closed end having a bore therethrough. An extractor member is provided having a handle on one end and a shaft portion extending through the bore. The shaft portion has at least first threaded portion opposite the handle and a second threaded portion adjacent the closed end. A lifting member is operably coupled to the second threaded portion.

### BACKGROUND OF THE INVENTION

The subject matter disclosed herein relates to tool for removing and installing plugs in a conduit and in particular to a tool for use with pipes having a pressurized gas therein.

Pressurized piping is commonly used to transport a fluid, such as natural gas for example, to an end use location. In natural gas applications, a gas main is often installed under or adjacent to a roadway with connection joints, sometimes referred to as a “service tee”, are installed periodically along the gas main. The connection joint includes a first pipe that extends at a right angle to the gas main. A second or service pipe extends from the first pipe and extends to the end use location, such as a residential home for example.

The end of the first pipe is closed by a plug that is press fit into the inner diameter of the first pipe. The plug has a threaded hole facing the exterior. In the event that service personnel need to open the connection joint, such as to shut off service to the service pipe for example, a bolt is attached to the threaded hole. The service personnel then manually remove the plug by pulling on the bolt until the plug is worked free. It should be appreciated that the gas main and the connection joint are under pressure. Commonly, natural gas distribution systems operate from ½ lb to 60 pounds. As a result of this pressure, once the plug is removed, natural gas will escape from the opening into the environment. Service personnel then have to work quickly to insert a smaller plug that can be inserted between the gas main and the service pipe to prevent further leakage of natural gas.

While existing tools and methods of removing plugs from connection joints are suitable for their intended purposes a need for improvement remains, particularly in providing a tool that allows the removal of the plug from the connection joint with little or no leakage of the pressurized gas.

### BRIEF DESCRIPTION OF THE INVENTION

According to one aspect of the invention, a tool for extracting a plug is provided. The tool includes a chamber member having an open end and a closed end, the closed end having a bore therethrough. An extractor member having a handle on one end and a shaft portion extends through the bore, the shaft portion having at least first threaded portion opposite the handle and a second threaded portion adjacent the closed end. A lifting member is operably coupled to the second threaded portion.

According to another aspect of the invention, another tool for extracting a plug is provided. The tool includes a valve. A chamber member having a first end is coupled to the valve and a second end, the chamber member having a substantially hollow interior portion, the second end having a bore therethrough. An extractor member having a shaft portion is slidably coupled to and at least partially disposed within the bore, the extractor member having a fastener portion on one end and a lifter portion adjacent the second end. A lifting member is operably coupled to the lifter portion.

According to yet another aspect of the invention, a method of extracting a plug from a natural gas service connection is provided. The method includes providing a tool having a chamber member having an open end and a closed end, the closed end having a bore therethrough. An extractor member is provided for the tool having a handle on one end and a shaft portion extending through the bore, the shaft portion having at least first threaded portion opposite the handle and a second threaded portion adjacent the closed end. A lifting member is provided for the tool operably coupled to the second threaded portion. A valve is removably coupled to the open end.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a side sectional view of a prior art connection joint;

FIG. 2 is a side sectional view of the plug removal and installation tool in accordance with an embodiment of the invention;

FIG. 3 is a side sectional view of the tool of FIG. 2 installed on the connection joint of FIG. 1;

FIG. 4 is a side sectional view of the tool and connection joint of FIG. 3 with the plug removed;

FIG. 5 is a side sectional view of a stopper installation tool;

FIG. 6 is a side sectional view of an embodiment of a stopper for use with the installation tool of FIG. 5; and,

FIG. 7 is a side sectional view of the tool and connection joint of FIG. 3 with the stopper installed.

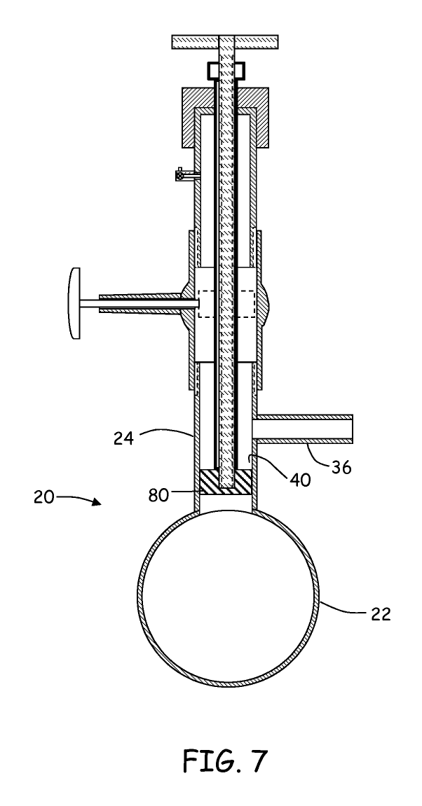

The detailed description explains embodiments of the invention, together with advantages and features, by way of example with reference to the drawings.

### DETAILED DESCRIPTION OF THE INVENTION

Embodiments of the present invention provide for a the removal and installation of plugs within a connection joint, such as those used in natural gas distribution systems. These embodiments provide advantages in allowing removal of the plug and installation of a new plug with little or no leakage of natural gas from the system.

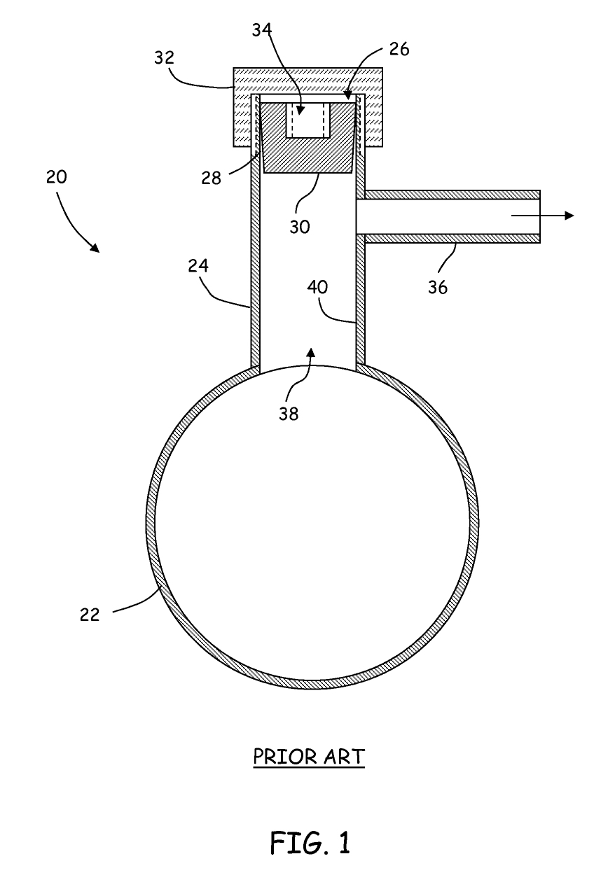

A typical connection joint 20 is shown in FIG. 1, such as that used to connect a gas main to an end use location in a natural gas distribution system for example. The connection joint 20 includes a gas main 22. The gas main 22 may be made of steel, cast iron or plastic of any suitable size, such as a pipe having a 4.5 inch (114.3 millimeter) outer diameter for example. A first pipe 24 extends from the gas main 22. The first pipe 24 includes an end 26 having an external threaded portion 28. The end 26 is open, therefore after installation, a plug 30 is installed in the end 26 and a cap 32 is threaded onto the first pipe 24. The plug 30 is generally made from steel and held in place by a press fit. The plug 30 typically includes a threaded hole 34 to facilitate removal of the plug 30 at a later date.

Extending from the first pipe 24 is a second pipe 36. It should be appreciated that the second pipe 36 is positioned between the plug 30 and an opening 38 from the gas main 22 into the first pipe 24. As will be discussed in more detail below, the service pipe 36 may be offset from the gas main 22 to provide an area 40 that allow a plug to be inserted and disconnect the service pipe 36.

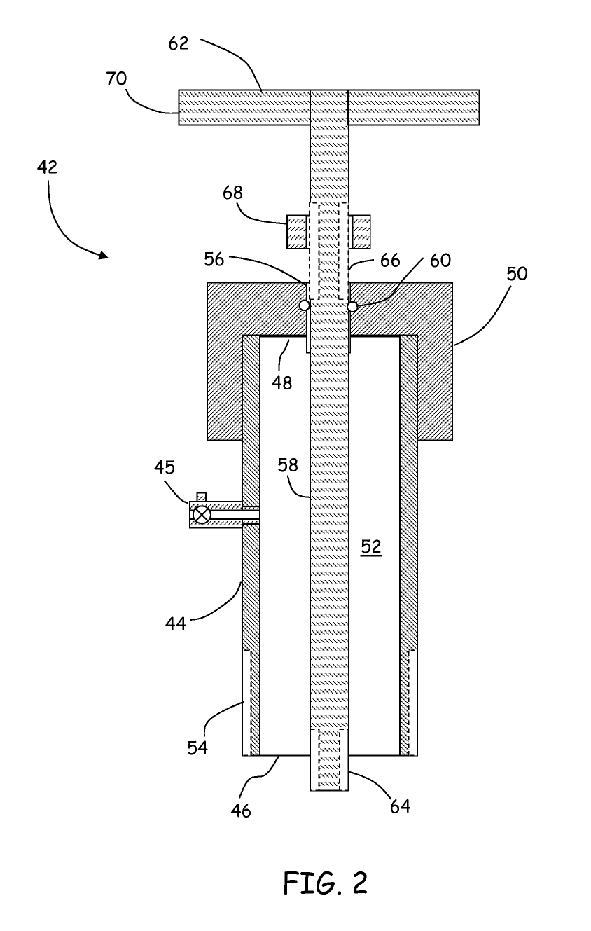

Referring now to FIG. 2, an exemplary embodiment is shown of a tool 42 for removing and installing plugs in the connection joint 20. The tool 42 includes a chamber member 44 having a substantially hollow interior portion 52, an open end 46 and a second end 48. As will be discussed in more detail below, the open end 46 has a threaded portion 54 that is configured to couple with a valve. The second end 48 is enclosed with a cap 50. The cap 50 has a bore 56 that is sized to allow a shaft 58 from an extractor 62 to extend therethrough. In one embodiment, the bore 56 includes a seal 60, such as an o-ring that forms a gas tight seal between the bore 56 and the shaft 58. In one embodiment, the chamber member 44 also includes a relief valve 45 that is fluidly coupled to the interior volume 52.

The extractor 62 includes the shaft 58 that is slidably disposed within the bore 56. The shaft 58 extends through the chamber member 44 and has a threaded portion 64. The threaded portion 64 is sized to couple with the threaded hole 34 of plug 30. The shaft 58 further includes a second threaded portion 66. In one embodiment, the shaft 58 has a thread extending along substantially the entire length of the shaft to form a continuous screw thread. A lifting member 68 is coupled to the second threaded portion 66 adjacent the top surface of the cap 50. On one end, the extractor 62 includes a handle 70, such as a T-handle.

As will be discussed in more detail below, in the exemplary embodiment, the lifting member 68 is a nut that has an internal screw thread that engages the second threaded portion 66. The nut may be moved against the top surface of the cap 50 such that the rotation of the nut will cause the extractor 62 to translate relative to the chamber member 44 and pull the plug 30 from the connection joint 20. In other embodiments, the lifting member may be a ratchet type mechanism that engages teeth on the extractor 62 to cause movement. In still other embodiments, the lifting member may be incorporated into the cap such as by threads in the bore 56 for example.

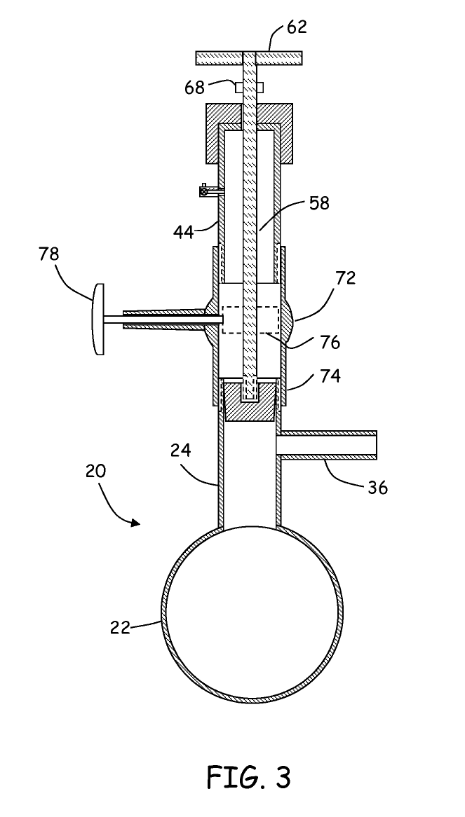

As shown in FIGS. 3-5, the threads 54 on chamber member 44 are sized to couple with a valve 72. The valve 72 may be any suitable valve type that is sufficient to prevent leakage from the connection joint 20 when the valve is closed, while also having an opening sufficiently large to allow the plug 30 to pass through when in the open position. In the exemplary embodiment, the valve 72 is a ball or gate type valve. The valve 72 has a threaded end 74 that is sized to couple with the threads 28 on first pipe 24. A valve assembly 76 is coupled to a handle 78 that allows service personnel to move the valve assembly 76 between a fully closed and a fully open position.

In operation, the service personnel typically first dig or otherwise expose the connection joint 20. The cap 30 is removed and the valve 72 is coupled to the first pipe 24. The chamber member 44 is coupled to an end of the valve 72 opposite the first pipe 24. The valve assembly 76 is opened and the shaft portion 58 is inserted through the valve assembly 76 allowing the threaded end 64 to engage the threaded hole 34 in plug 30 (FIG. 3). It should be appreciated that the coupling of the valve 72 and chamber member 44 to the first pipe 24 that a substantially sealed area is formed over the end of the first pipe 24 to reduce or prevent leakage of natural gas.

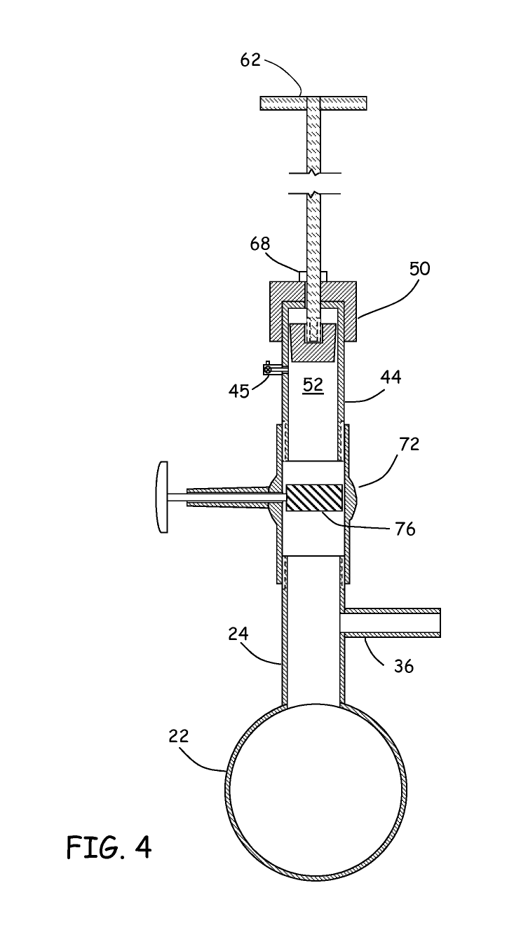

With the extractor 62 coupled to the plug 30, the lifting member 68 is rotated against the top surface of the cap 50. Once the lifting member 68 is against the cap 50, further rotation of the lifting member 68 causes the extractor 62 to move in a direction away from the connection joint 20. As the extractor 62 moves, the plug 30 will be removed from the first pipe 24. Continued rotation of the lifting member 68 results in the plug 30 passing through the valve assembly 76 and into the interior portion 52 of chamber member 44. With the plug 30 within the chamber member 44, the valve assembly 76 may be actuated to the closed position (FIG. 4). It should be appreciated that with the valve 72 closed, the interior portion 52 of the chamber member 44 is isolated from the end of the first pipe 24.

In one embodiment, the chamber member 44 includes a relief valve 45. With the valve 72 closed, the relief valve 45 may be activated to release a small amount of pressurized gas from within the interior volume 52. The chamber member 44 may then be removed from the valve 72 and the plug 30 detected from the extractor 62. It should be appreciated that since the valve 72 is closed, that substantially no natural gas will leak from the gas main when the chamber member 44 is removed.

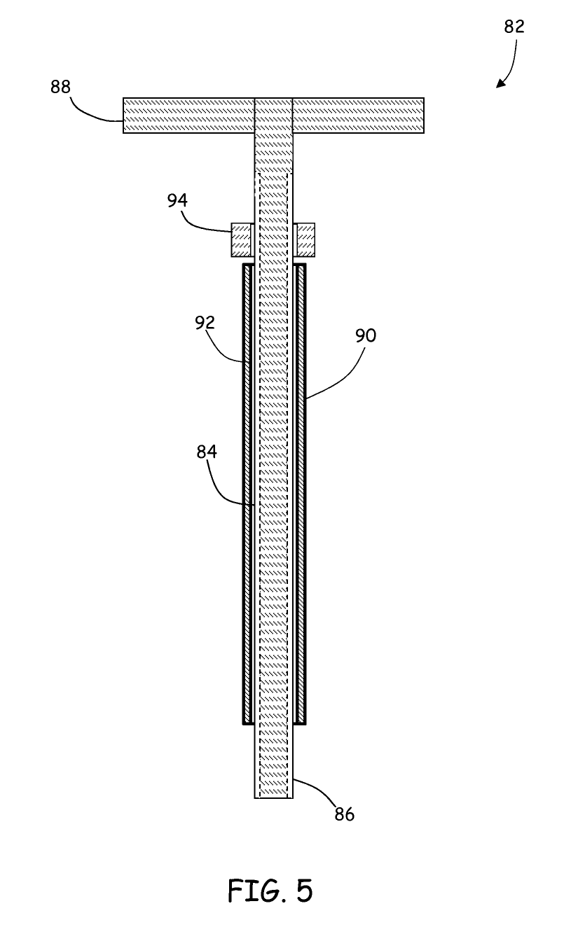

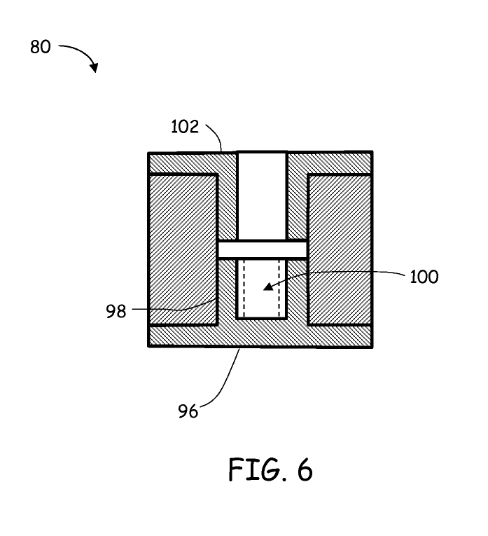

With the plug 30 detached, the service personnel may then attach a new plug 80, sometimes referred to as a stopper unit 80 (FIG. 6) on to a stopper installation tool 82 (FIG. 5). The stopper installation tool 82 is includes a threaded rod portion 84 having a screw thread sized to couple with the stopper unit 80 on end 86. On an opposite end, the installation tool 82 includes a handle 88. A tube 90 having an inner bore 92 is disposed about the threaded rod portion 84. An operating nut 94 is coupled to the threaded rod portion 84 on an end opposite the end 86.

One embodiment of the stopper unit 80 is shown in FIG. 6. In this embodiment, the stopper 80 includes a first member 96 having a projection 98. The projection 98 includes a threaded bore 100. Disposed opposite the first member 96 is a second member 102. The second member 102 includes a projection 104 having a center bore 106 extending therethrough. The center bore 106 is sized to allow the threaded rod portion 84 to be inserted and coupled with the threaded bore 100. Disposed between the first member 96 and the second member 102 is a stopper member 108. In the exemplary embodiment, the stopper member 108 is made from a rubber or plastic material having sufficient elasticity to deform when compressed between the first member 96 and the second member 102. When assembled, the end 110 of the projection 98 and the end 112 of projection 104 are spaced apart about 0.125 inches (3.175 millimeters). It should be appreciated that the stopper 80 has an outer diameter and a height sized to fit within the area 40 of pipe 24. As will be discussed in more detail below, when the stopper 80 is inserted into area 40 with the installation tool 82, the service personnel may tighten the operating nut 94 onto the tube 84. The tightening of the operating nut will cause the first member 96 to move towards the second member 102 compressing the stopper member 108. This causes the stopper member 108 to expand and form a seal against the inner diameter of pipe 24.

It should be appreciated that the stopper unit 80 will remain compressed only when the installation tool 82 is coupled to the stopper unit 80. This provides advantages in allowing the stopper unit to be easily and repeatably installed and removed be service personnel.

In another embodiment, the stopper unit is a 2 inch Expander Plug Model manufactured by Mueller Company. Unlike the stopper plug described above, the Expander Plug may be permanently installed in the pipe 24 since the Expander Plug is configured to remain in the sealed position when the installation tool is decoupled.

To install the stopper unit 80, the installation tool 82 is inserted through the bore 56 and into the chamber member 44. The stopper unit 80 is coupled to the end 86 and moved into the interior portion 52. The chamber member 44 is then coupled to the valve 72 and the valve assembly 76 is opened. With the valve assembly 76 open, the threaded rod portion 84 and stopper unit 80 may be inserted through the valve 72 until the stopper unit 80 is positioned in area 40 between the service pipe 36 and the gas main 22. The stopper unit 80 is then actuated by rotating the extractor 62 causing the stopper unit 80 to seal against the inner diameter of the first pipe 24. With the stopper unit 80 installed, the service pipe 36 is isolated from the gas main 22 and service work may be commenced on the line. Once the service work is complete, the process may be reversed with the stopper unit 80 being moved into the chamber member 44, the valve 72 closed. The chamber member 44 is removed from the valve 72 to retrieve the stopper member 80. The plug 30 may be reinstalled using the extractor 62, attaching the chamber member 44 to the valve 72. The valve 72 is opened and the plug 30 pressed back into the first pipe 24. In some embodiments, the service personnel may tap the extractor 62 with a mallet to obtain the desired seating of the plug 30. The extractor 62 is then removed from the plug 30 and the valve 72 and tool 42 detached from the connection joint 20. Finally, the cap 32 reattached to the first pipe 24.

It should be appreciated that while embodiments herein refer to a natural gas distribution system, the claimed invention should not be so limited and embodiments of the present invention may be used in any application having a pressurized gas being carried by a conduit where a plug needs to be removed while reducing or eliminating leakage during the extraction.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A tool for extracting a plug comprising:
a chamber member having an open end and a closed end, the closed end having a bore therethrough;
an extractor member having a handle on one end and a shaft portion extending through the bore, the shaft portion having at least first threaded portion opposite the handle and a second threaded portion adjacent the closed end; and,
a lifting member operably coupled to the second threaded portion.

2. The tool of claim 1 further comprising a relief valve fluidly coupled to the chamber.

3. The tool of claim 2 further comprising a valve coupled to the open end.

4. The tool of claim 3 wherein the extractor member is movable between a first position and a second position, wherein the extractor member moves from the first position to the second position in response to the rotation of the lifting member.

5. The tool of claim 4 wherein the lifting member is in contact with the closed end.

6. The tool of claim 5 further comprising a seal disposed between the shaft portion and the bore.

7. The tool of claim 1 further comprising:
an insertion tool having a third threaded portion and a tube member disposed about the third threaded portion; and
a stopper unit having a first member, a second member and an elastic member disposed between the first member and the second member, the first member being removably coupled to the third threaded portion, wherein the elastic member expands in response to rotation of the insertion tool.

8. A tool for extracting a plug comprising:
a valve;
a chamber member having a first end coupled to the valve and a second end, the chamber member having a substantially hollow interior portion, the second end having a bore therethrough;
an extractor member having a shaft portion slidably coupled to and at least partially disposed within the bore, the extractor member having a fastener portion on one end and a lifter portion adjacent the second end; and,
a lifting member operably coupled to the lifter portion.

9. The tool of claim 8 wherein the lifting member is a nut and the lifter portion is a threaded portion, the nut being movably disposed to engage the closed end.

10. The tool of claim 8 wherein the lifting member is a threaded portion disposed in the bore.

11. The tool of claim 8 wherein the lifting member is a ratchet mechanism and the lifter portion includes teeth disposed to engage the ratchet mechanism.

12. The tool of claim 11 wherein the extractor member is movable between a first position and a second position in response to actuation of the lifting member.

13. The tool of claim 12 further comprising:
an insertion tool having a threaded portion and a tube member disposed at least partially about the threaded portion;
a stopper unit having a first member coupled to the threaded portion, the stopper unit further having a second member and an elastic member disposed between the first member and the second member, wherein the elastic member expands in response to rotation of the threaded portion.

14. A method of extracting a plug from a natural gas service connection, the method comprising:
providing a tool having a chamber member having an open end and a closed end, the closed end having a bore therethrough;
providing an extractor member for the tool having a handle on one end and a shaft portion extending through the bore, the shaft portion having at least first threaded portion opposite the handle and a second threaded portion adjacent the closed end;
providing a lifting member for the tool operably coupled to the second threaded portion; and,
providing a valve removably coupled to the open end.

15. The method of claim 14 further comprising coupling the valve to the service connection adjacent the plug.

16. The method of claim 15 further comprising:
coupling the first threaded portion to the plug;
actuating the lifting member; and,
moving the shaft portion from a first position to a second position, wherein the plug is moved within the chamber member when the shaft is in the second position.

17. The method of claim 16 further comprising:
closing the valve; and,
removing the chamber member from the valve.

18. The method of claim 17 further comprising:
removing the plug from the first threaded portion;
coupling a second plug to the first threaded portion; and
coupling the chamber member to the valve.

19. The method of claim 18 further comprising:
opening the valve;
inserting the second plug into the service connection between a service pipe and a main pipe; and,
detaching the first threaded portion from the second plug.

20. The method of claim 17 further comprising:
providing a relief valve fluidly coupled to the chamber member; and,
opening the relief valve before removing the chamber member from the valve.
